(19) United States
(12) Patent Application Publication
(10) Pub. No.: US 2026/0319401 A1
(43) Pub. Date: Oct. 15, 2026

(54) ELECTROPHOTOGRAPHIC IMAGE FORMING APPARATUS

(71) Applicant: KYOCERA Document Solutions Inc., Osaka (JP)

(72) Inventor: Teppei SHIBUYA, Osaka (JP)

(73) Assignee: KYOCERA Document Solutions Inc., Osaka (JP)

(21) Appl. No.: 19/640,504

(22) Filed: Apr. 7, 2026

(30) Foreign Application Priority Data
Apr. 10, 2025 (JP) 2025-065285

(51) Int. Cl. G03G 15/16; G03G 15/00; G03G 15/01

(52) U.S. Cl. CPC G03G 15/1675; G03G 15/0131; G03G 15/5037; G03G 2215/0129

(57) ABSTRACT

A controller controls a transfer bias to be applied to transfer devices by setting a value of a transfer current flowing through a transfer device to a smaller value when an image area of a toner image in a longitudinal direction corresponding to a rotation axis direction of an image carrier becomes narrower on the basis of information about the toner image on the image carrier at a transfer nip formed between the image carrier and an intermediate transfer medium and setting the transfer current value to a smaller value when a toner amount of the toner image becomes smaller.

### INCORPORATION BY REFERENCE

This application claims priority to Japanese Patent Application No. 2025-065285 filed on Apr. 10, 2025, the entire contents of which are incorporated by reference herein.

### BACKGROUND

The present disclosure relates to an electrophotographic image forming apparatus.

In image forming apparatuses such as electrophotographic copiers and multifunctional devices, a tandem-type image forming apparatus includes photosensitive drums respectively corresponding to a plurality of colors; charging devices configured to charge surfaces of the photosensitive drums; exposure devices configured to expose the surfaces of the photosensitive drums to form electrostatic latent images on the surfaces of the photosensitive drums; developing devices configured to form toner images on the surfaces of the photosensitive drums; an intermediate transfer belt configured to come into contact with the surfaces of the photosensitive drums so that the toner images on the photosensitive drums are transferred thereto; and transfer devices configured to transfer the toner images from the photosensitive drums to the intermediate transfer belt, wherein toner images of respective colors formed on the photosensitive drums are sequentially superimposed on the intermediate transfer belt to form a color image.

The transfer device includes a transfer roller. A transfer bias is applied to the transfer roller, a current (transfer current) flows through the transfer roller by application of the transfer bias, the toner image formed on the surface of the photosensitive drum is attracted toward the transfer roller, and the toner image is transferred to the intermediate transfer belt.

### SUMMARY

According to an aspect of the present disclosure, an image forming apparatus includes a plurality of image carriers, a plurality of charging devices, a plurality of exposure devices, a plurality of developing devices, an intermediate transfer medium, a plurality of transfer devices, and a control device. The plurality of image carriers are provided for a plurality of colors and rotate about a rotation axis and carry a toner image. The plurality of charging devices are provided for the plurality of colors and charge surfaces of the image carriers. The plurality of exposure devices are provided for the plurality of colors and expose the surfaces of the image carriers to form electrostatic latent images on the surfaces of the image carriers. The plurality of developing devices are provided for the plurality of colors and supply toner to the surfaces of the image carriers to develop the electrostatic latent images formed on the surfaces of the image carriers and form toner images. The intermediate transfer medium travels in a direction in which the image carriers are arranged and sequentially contact the surfaces of the image carriers, wherein the toner images on the image carriers are transferred onto the intermediate transfer medium. The plurality of transfer devices are provided for the plurality of colors and transfer the toner images on the corresponding image carriers to the intermediate transfer medium. The control device includes a processor. When the processor executes a control program, the control unit functions as a controller. The controller controls a transfer bias to be applied to the transfer devices by setting a value of a transfer current flowing through a transfer device to a smaller value when an image area of the toner image in a longitudinal direction corresponding to a rotation axis direction of the image carrier becomes narrower on the basis of information about the toner image on the image carrier at a transfer nip formed between the image carrier and the intermediate transfer medium and setting the transfer current value to a smaller value when a toner amount of the toner image becomes smaller.

### BRIEF DESCRIPTION OF THE DRAWINGS

FIG. 1 is a front sectional view showing a structure of an image forming apparatus according to an embodiment of the present disclosure.

FIG. 2 is a functional block diagram schematically showing a main internal configuration of the image forming apparatus according to an embodiment of the present disclosure.

FIG. 3 is an enlarged view of an image forming device included in the image forming apparatus.

FIG. 4 is a diagram showing blocks into which image data is divided.

FIG. 5 is an explanatory diagram showing division areas into which a surface of a photosensitive drum is divided.

FIG. 6 is a flowchart showing an example of a process performed by a control device of the image forming apparatus.

FIG. 7A is a graph showing a relationship between a density of a toner image formed on a photosensitive drum and a transfer current value required to transfer the toner image of that density to an intermediate transfer belt.

FIG. 7B is a graph showing a relationship between a density of a toner image formed on the photosensitive drum and a transfer current value required to transfer the toner image of that density to the intermediate transfer belt.

FIG. 8A is a graph showing a relationship between a density of a toner image formed on the photosensitive drum and a transfer current value required to transfer the toner image of that density to the intermediate transfer belt.

FIG. 8B is a graph showing a relationship between a density of a toner image formed on the photosensitive drum and a transfer current value required to transfer the toner image of that density to the intermediate transfer belt.

FIG. 9 is a diagram showing an example of magnitude relationships of transfer current values.

FIG. 10A is a diagram showing an example of magnitude relationships of transfer current values required for transfer according to states of toner images.

FIG. 10B is a diagram showing an example of magnitude relationships of transfer current values required for transfer according to states of toner images.

FIG. 11A is a diagram showing an example of magnitude relationships of transfer current values required for transfer according to states of toner images.

FIG. 11B is a diagram showing an example of magnitude relationships of transfer current values required for transfer according to states of toner images.

FIG. 12A is a graph showing a relationship between a density of a toner image formed on the photosensitive drum and a transfer current value required to transfer the toner image of that density to the intermediate transfer belt.

FIG. 12B is a graph showing a relationship between a density of a toner image formed on the photosensitive drum and a transfer current value required to transfer the toner image of that density to the intermediate transfer belt.

FIG. 13A is a graph showing a relationship between a density of a toner image formed on the photosensitive drum and a transfer current value required to transfer the toner image of that density to the intermediate transfer belt.

FIG. 13B is a graph showing a relationship between a density of a toner image formed on the photosensitive drum and a transfer current value required to transfer the toner image of that density to the intermediate transfer belt.

### DETAILED DESCRIPTION

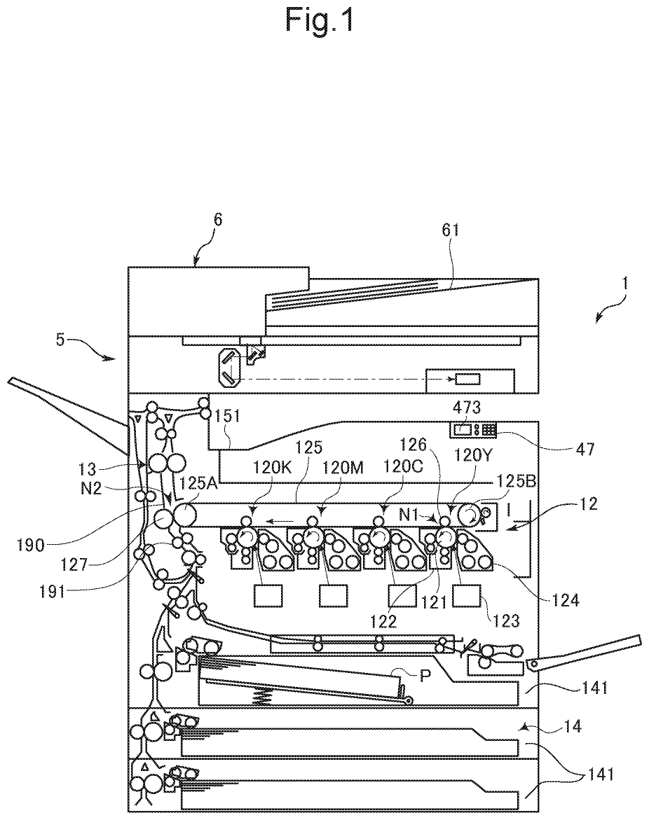

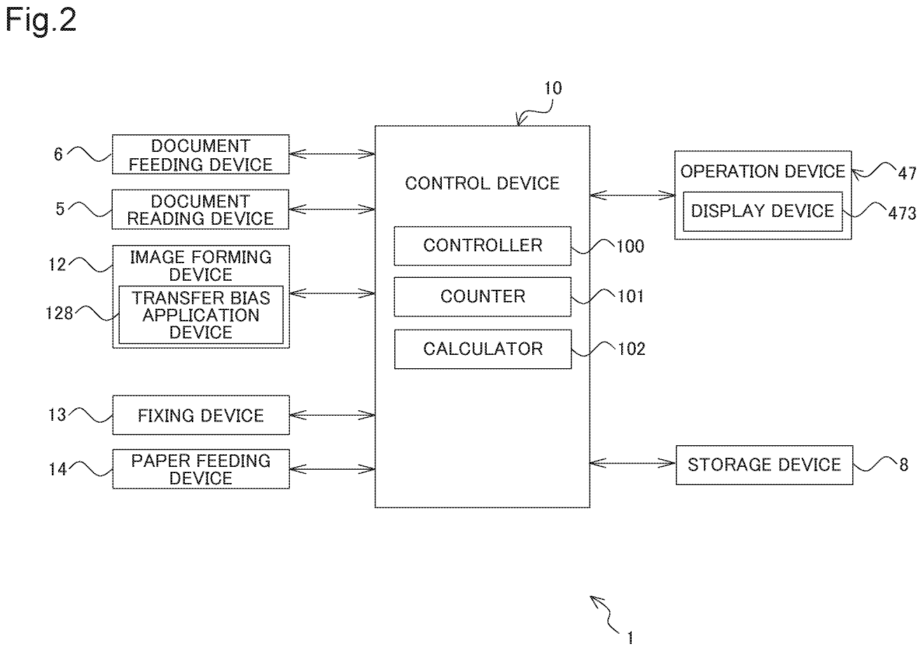

Hereinafter, an image forming apparatus according to an embodiment of the present disclosure will be described with reference to the drawings. FIG. 1 is a front sectional view showing a structure of an image forming apparatus according to an embodiment of the present disclosure. FIG. 2 is a functional block diagram schematically showing a main internal configuration of the image forming apparatus according to an embodiment of the present disclosure.

An image forming apparatus 1 is, for example, a multifunctional device having a plurality of functions such as a copying function, a printer function, a scanner function, and a facsimile function. The image forming apparatus 1 is configured to include a control device 10, a document feeding device 6, a document reading device 5, an image forming device 12, a fixing device 13, a paper feeding device 14, an operation device 47, and a storage device 8.

The document feeding device 6 is configured to be openable and closable with respect to an upper surface of the document reading device 5 by hinges (not shown). When a document placed on a platen glass (not shown) is read, the document feeding device 6 functions as a document pressing cover. Moreover, the document feeding device 6 is also an auto document feeder (ADF), includes a document tray 61, and supplies documents placed on the document tray 61 to the document reading device 5.

The document reading device 5 includes a scanner and reads a document supplied from the document feeding device 6 or a document placed on the platen glass.

A case where a document reading operation is performed by the image forming apparatus 1 will be described. The document reading device 5 optically reads an image of a document supplied from the document feeding device 6 or placed on the platen glass and generates image data. The image data generated by the document reading device 5 is stored in an image memory (not shown) or the like.

A case where an image forming operation is performed by the image forming apparatus 1 will be described. The image forming device 12 includes image forming devices 120Y, 120C, 120M, and 120K for respective colors of yellow, cyan, magenta, and black (hereinafter collectively referred to as “image forming devices 120”). Each image forming device 120 includes a photosensitive drum 121 serving as an image carrier that carries a toner image, a charging device 122, an exposure device 123, a developing device 124, and a primary transfer device (primary transfer roller 126). It is a mechanism that forms an image on recording paper serving as a recording medium by secondary transfer via an intermediate transfer belt 125 stretched over a driving roller 125A and a driven roller 125B. In addition, the photosensitive drum 121, the primary transfer roller 126, and the intermediate transfer belt 125 are examples of an image carrier, a transfer device, and an intermediate transfer medium, respectively, as recited in the claims.

The charging device 122 charges a surface of the photosensitive drum 121. The exposure device 123 exposes the charged surface of the photosensitive drum 121 to form an electrostatic latent image on the surface of the photosensitive drum 121. The developing device 124 contains toner for developing the electrostatic latent image and develops the electrostatic latent image formed on the surface of the photosensitive drum 121.

The image forming device 120 for each color forms a toner image on the photosensitive drum 121 according to charging, exposure, and developing processes on the basis of an image of a corresponding color component, and transfers the toner image onto the intermediate transfer belt 125 by the primary transfer roller 126. That is, the primary transfer roller 126 transfers the toner image on the photosensitive drum 121 onto the intermediate transfer belt 125 at a transfer nip N1 formed between the photosensitive drum 121 and the intermediate transfer belt 125.

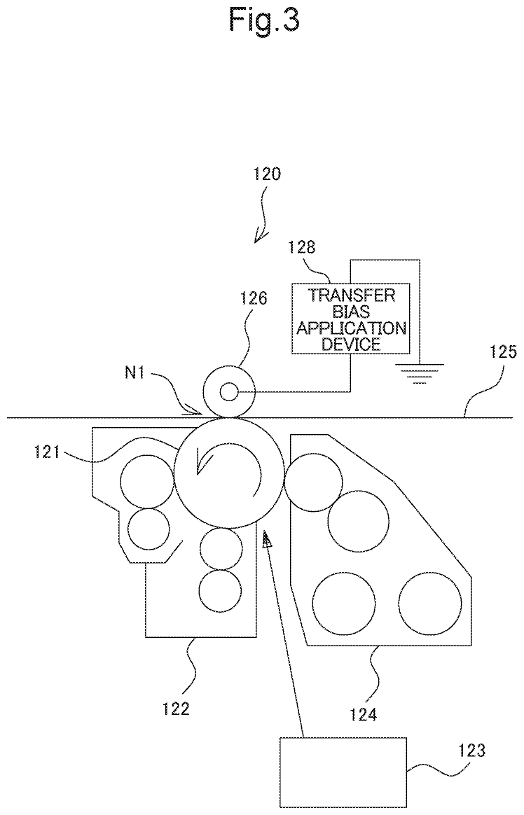

FIG. 3 is an enlarged view of the image forming device 120. As shown in FIG. 3, a transfer bias is applied to the primary transfer roller 126 by a transfer bias application device (power supply) 128, so that a current (transfer current) flows through the primary transfer roller 126. The transfer bias applied to the primary transfer roller 126 is controlled by the controller 100 to be described below.

The photosensitive drum 121 is formed of, for example, amorphous silicon (a-Si) or an organic photoconductor (OPC). When an OPC is used as the photosensitive drum 121, it is preferable to perform pre-transfer charge removal.

The intermediate transfer belt 125 is, for example, a single-layer or multilayer resin belt. Examples of a base layer material include polyamide (PA), polyvinylidene fluoride (PVDF), polyimide (PI), polyamide-imide (PAI), polyether ether ketone (PEEK), polyethylene naphthalate (PEN), polyethylene terephthalate (PET), and polycarbonate (PC). Moreover, a multilayer belt having an elastic layer may be adopted as the intermediate transfer belt 125.

In the intermediate transfer belt 125, an image carrying surface on which toner images are transferred onto its outer surface is set. The intermediate transfer belt 125 is driven by the driving roller 125A in contact with the surface of the photosensitive drum 121. The intermediate transfer belt 125 endlessly travels between the driving roller 125A and the driven roller 125B in synchronization with the photosensitive drums 121.

Toner images of colors transferred onto the intermediate transfer belt 125 are superimposed on the intermediate transfer belt 125 to form a color toner image. A secondary transfer roller 127 transfers the color toner image formed on the surface of the intermediate transfer belt 125 onto recording paper P conveyed from the paper feeding device 14 by a pair of conveyance rollers 191 provided at an appropriate position of a conveyance path 190, at a secondary transfer nip N2 between the driving roller 125A and the secondary transfer roller 127 with the intermediate transfer belt 125 interposed.

Under control of the controller 100, the image forming device 12 forms a toner image on the recording paper P fed from the paper feeding device 14 on the basis of image data generated by a document reading operation, image data stored in an image memory or the like, image data received from a network-connected computer, or the like, thereby producing a printed output.

The paper feeding device 14 includes a paper feeding cassette 141, and further includes a pickup roller that picks up the recording paper P from the paper feeding cassette 141 and feeds the recording paper P to the image forming device 12, a conveyance roller, a conveyance path, and a rotation driving mechanism for each roller.

The fixing device 13 is a fixing device including a heat roller, a pressure roller, and a driving mechanism for rotationally driving the heat roller and the pressure roller. The fixing device 13 heats and presses the recording paper P, on which a toner image has been formed by the image forming device 12, at a nip formed by the heat roller and the pressure roller to fix the toner image onto the recording paper P. The recording paper P subjected to the fixing process is discharged to a discharge tray 151.

The operation device 47 includes various types of hard keys operated by a user, and receives instructions from the user, such as instructions to execute image forming operations, in accordance with operations of the hard keys, with respect to various types of operations and processes executable by the image forming apparatus 1.

The operation device 47 includes a display device 473 that displays operation guidance and the like to an operator. Moreover, the operation device 47 receives input of instructions from the user based on user operations (touch operations) on a screen displayed on the display device 473 via a touch panel included in the display device 473.

The display device 473 includes, for example, a liquid crystal display (LCD). When the operator performs an operation for touching a button or key displayed on the screen, the touch panel receives an instruction associated with the touched position. In this case, the touch panel functions as an operation device.

The storage device 8 is a large-capacity storage device such as a hard disk drive (HDD) or a solid-state drive (SSD), and stores various control programs and the like.

The control device 10 is configured to include a processor, a random-access memory (RAM), a read-only memory (ROM), and a dedicated hardware circuit. The processor is, for example, a central processing unit (CPU), an application-specific integrated circuit (ASIC), a micro-processing unit (MPU), or the like. The control device 10 includes a controller 100, a counter 101, and a calculator 102.

The control device 10 functions as the controller 100, the counter 101, and the calculator 102 according to operations of the processor in accordance with control programs stored in the storage device 8. However, the controller 100 and the like may include respective hardware circuits, regardless of operations according to control programs executed by the control device 10. Unless otherwise specified, the same is true for each embodiment to be described below.

The controller 100 controls overall operations of the image forming apparatus 1. The controller 100 is connected to the document feeding device 6, the document reading device 5, the image forming device 12, the fixing device 13, the paper feeding device 14, the operation device 47, and the storage device 8, and performs drive control and the like for these devices. For example, the controller 100 executes various types of processes required for image formation by the image forming apparatus 1.

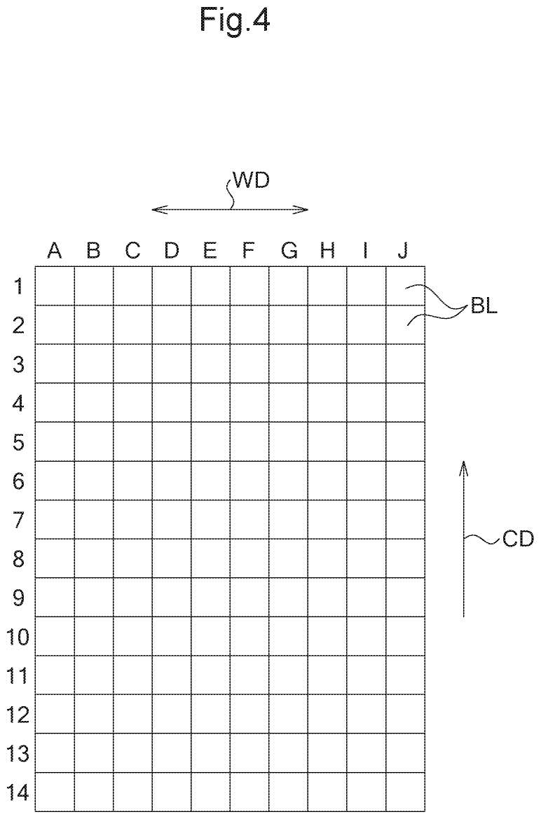

The counter 101 counts the number of dots (density) of each color required to form an image represented by the image data for each of a plurality of blocks formed by dividing image data to be printed along a conveyance direction of a recording medium and a width direction orthogonal to the conveyance direction. For example, the counter 101 analyzes image data on a per-page basis, and as shown in FIG. 4, divides the image data into square blocks BL of 14 rows (first to fourteenth rows) in a conveyance direction CD (vertical direction in FIGS. 4) and 10 columns (columns A to J) in a width direction WD (horizontal direction in FIG. 4), and counts the number of dots for each block BL. Although a case where the number of blocks is 140(=10 ×14) is shown here for ease of description, it is actually preferable to further decrease the size of each block BL and further increase the number of blocks BL.

The calculator 102 calculates an image area (an image width in the width direction WD) and a toner amount (a toner density) of a toner image formed on the surface of the photosensitive drum 121 for each division area extending in the longitudinal direction (the width direction WD), which is a rotation axis direction of the photosensitive drum 121, by dividing the surface of the photosensitive drum 121 at predetermined intervals in a circumferential direction, on the basis of the number of dots of each block BL for each color counted by the counter 101. For example, the calculator 102 determines blocks BL having the number of dots equal to or greater than a predetermined value as the image area of the toner image, on the basis of the number of dots of the blocks BL belonging to the division area, and uses the number of dots of each block BL or a value obtained by multiplying the number of dots by a coefficient as the toner amount. However, a method for calculating the image area and the toner amount of the toner image in the calculator 102 is not limited to the above.

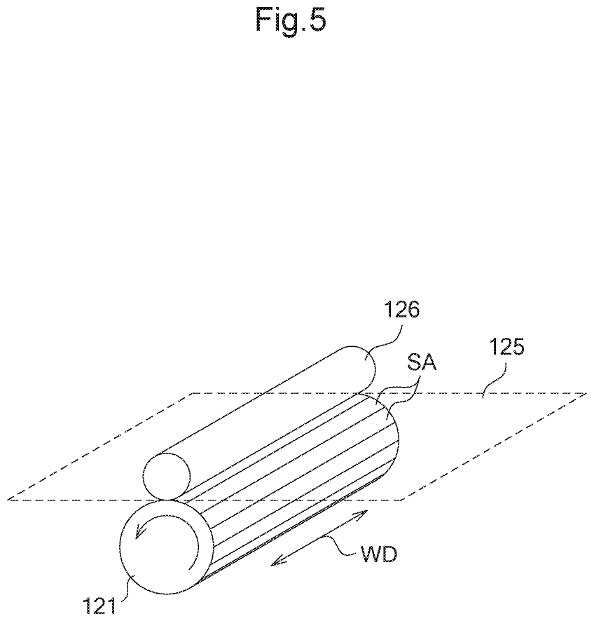

FIG. 5 is an explanatory diagram of division areas formed by dividing the surface of the photosensitive drum 121 as described above. As shown in FIG. 5, the division areas SA extend along the width direction WD and are arranged in the circumferential direction. Although the size and number of the division areas SA shown in FIG. 5 are simplified examples for ease of description, the width of each division area SA preferably has a size corresponding to a nip width of the transfer nip N1 formed between the photosensitive drum 121 and the intermediate transfer belt 125.

In the present embodiment, on the basis of information about a toner image on the photosensitive drum 121 at the transfer nip N1 formed between the photosensitive drum 121 and the intermediate transfer belt 125, the controller 100 sets a value of a transfer current flowing through the primary transfer roller 126 to a smaller value when the image area of the toner image in the longitudinal direction (width direction WD) becomes narrower (shorter) and sets the transfer current value to a smaller value when the toner amount of the toner image becomes smaller, thereby controlling a transfer bias to be applied to the primary transfer roller 126.

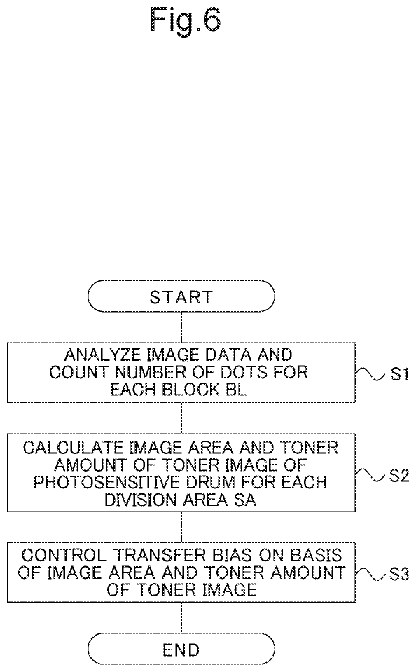

An example of such control of the transfer bias will be described with reference to the flowchart shown in FIG. 6.

The counter 101 analyzes image data for one page of a print-target document and counts the number of dots based on the image data for each of the plurality of blocks BL (S1). Subsequently, the calculator 102 calculates, for each division area SA of the photosensitive drum 121, an image area (an image width in the width direction WD) and a toner amount (a toner density) of a toner image formed on the surface of the photosensitive drum 121, on the basis of the number of dots counted by the counter 101 (S2).

On the basis of the image area and the toner amount of the toner image for each division area SA formed on the surface of the photosensitive drum 121, the controller 100 controls driving of the transfer bias application device 128 and adjusts the transfer current value (S3). The controller 100 iteratively continues this process until the process for one page is completed. Details of the adjustment will be described below.

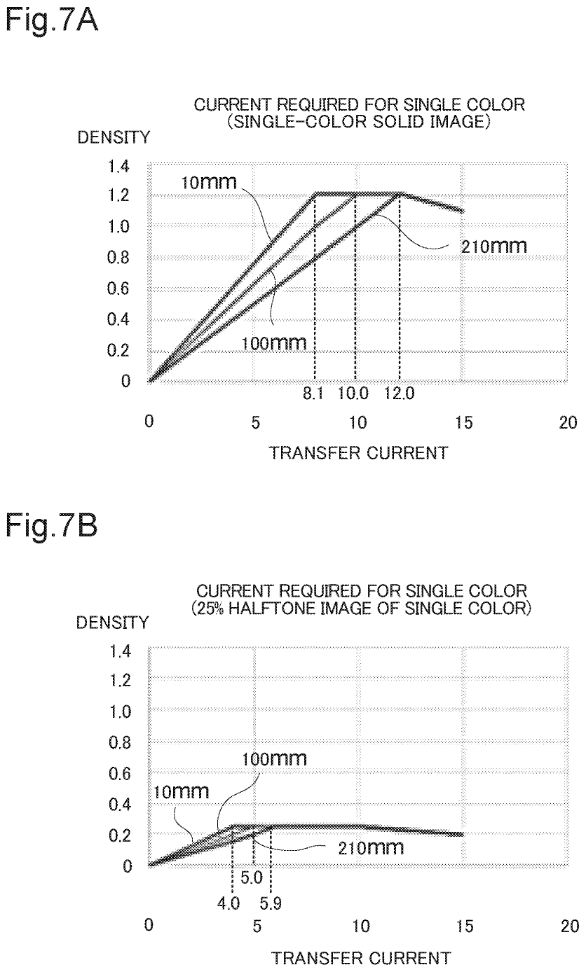

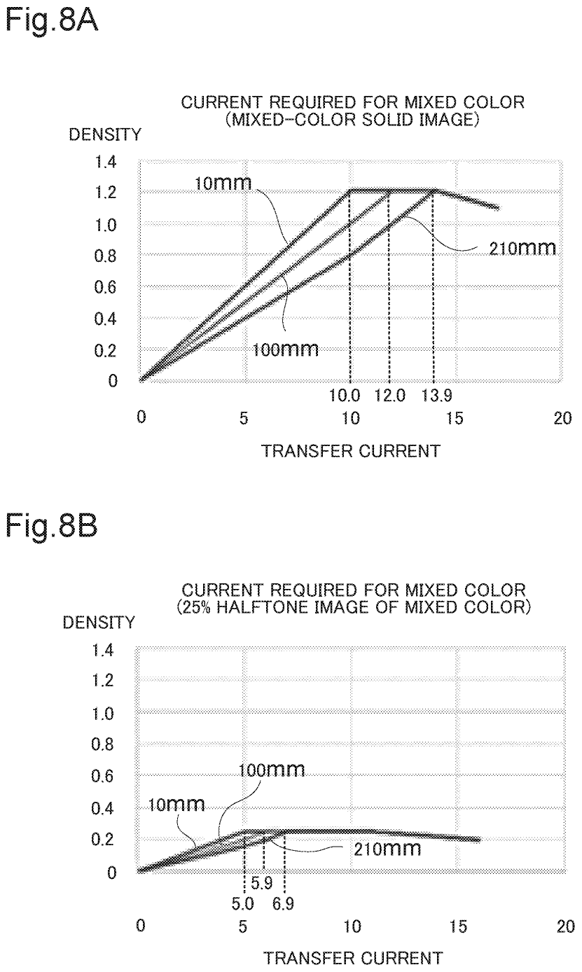

FIGS. 7A, 7B, 8A, and 8B are graphs showing relationships between a density of a toner image formed on the photosensitive drum 121 and a transfer current value required to transfer the toner image of that density to the intermediate transfer belt 125. This transfer current value is obtained in advance by experiments and the like. In addition, the measured values shown in FIGS. 7A, 7B, 8A, and 8B are obtained using the photosensitive drum 121 in which a potential difference |Vo−Vt| between a surface potential Vo of a non-image area (a background area that is not exposed) and a surface potential Vt of a solid image area (a portion exposed at a maximum level with a density of 100%) is within 100 V.

When the image forming apparatus 1 is of a tandem type, toner images of respective colors are sequentially transferred onto the intermediate transfer belt 125, and two or more toner images are superimposed on the intermediate transfer belt 125, thereby forming a toner layer based on a toner image of two or more colors on the intermediate transfer belt 125. For example, yellow toner and magenta toner are superimposed to form a toner layer (a red image) based on yellow and magenta toner.

That is, at the transfer nip N1, a toner layer formed on the intermediate transfer belt 125 by contact with the photosensitive drum 121 on the upstream side may overlap a toner image newly transferred to the intermediate transfer belt 125 by the photosensitive drum 121 on the downstream side.

FIGS. 7A and 7B are graphs showing a relationship between a toner density and a transfer current value required for transfer in a single-color transfer case in which a toner image of a new color is not transferred onto a toner image of another color. FIG. 7A shows transfer current values for toner images having a density of 100% (solid images) and image widths of 10 mm, 100 mm, and 210 mm. FIG. 7B shows transfer current values required for transferring toner images having a density of 25% (halftone images) and image widths of 10 mm, 100 mm, and 210 mm.

On the other hand, FIGS. 8A and 8B are graphs showing relationships between a toner density and a transfer current value required for transfer in a mixed-color transfer case in which a toner image of another color is superimposed and transferred onto a toner image of a given color. Moreover, FIG. 8A shows transfer current values required for transferring toner images having a density of 100% (solid images) and image widths of 10 mm, 100 mm, and 210 mm. FIG. 8B shows transfer current values required for transferring toner images having a density of 25% (halftone images) and image widths of 10 mm, 100 mm, and 210 mm.

As shown in FIG. 7A, when a solid image for single-color transfer is used, the transfer current values required for image widths of 10 mm, 100 mm, and 210 mm are approximately 8.1 μA, 10.0 μA, and 12.0 μA, respectively. As shown in FIG. 7B, when a halftone image for single-color transfer is used, the transfer current values required for image widths of 10 mm, 100 mm, and 210 mm are approximately 4.0 μA, 5.0 μA, and 5.9 μA, respectively.

As shown in FIG. 8A, when a solid image for mixed-color transfer (two to four colors) is used, the transfer current values required for image widths of 10 mm, 100 mm, and 210 mm are approximately 10.0 μA, 12.0 μA, and 13.9 μA, respectively. As shown in FIG. 8B, when a halftone image for mixed-color transfer (two to four colors) is used, the transfer current values required for image widths of 10 mm, 100 mm, and 210 mm are approximately 5.0 μA, 5.9 μA, and 6.9 μA, respectively.

The values shown in FIGS. 7A, 7B, 8A, and 8B indicate that, when the density of the toner image is the same even if the transfer is single-color transfer or mixed-color transfer, the larger the image width, the larger the transfer current value required for transfer. Thus, the narrower the image area of the toner image on the photosensitive drum 121, the smaller the required transfer current value.

Moreover, FIGS. 7A and 7B show that, if the image width of the toner image is the same, a solid image having a higher density (a larger toner amount) requires a larger transfer current value than a halftone image. That is, even if the transfer is single-color transfer or mixed-color transfer, the higher the density, the larger the required transfer current value. Thus, the smaller the toner amount of the toner image on the photosensitive drum 121, the smaller the required transfer current value.

Therefore, if the transfer bias is controlled using the required transfer current value when, for example, the image width or the toner amount of the toner image is at a maximum, regardless of the image width and the toner amount of the toner image serving as a transfer target, an excessive transfer current value is used to apply the transfer voltage when the image width or the toner amount of the toner image is smaller than the maximum value. On the basis of this, in the present embodiment, the controller 100 controls the transfer bias by setting the transfer current value selected from predetermined values defined so that the transfer current value decreases as the image area of the toner image in the above-described longitudinal direction (width direction WD) decreases and/or alternatively setting the transfer current value selected from predetermined values defined so that the transfer current value decreases as the toner amount of the toner image decreases. That is, in the present embodiment, the transfer voltage is applied while limiting the transfer current value to that required for transfer in accordance with the image width or the toner amount of the toner image, thereby suppressing an excessive current.

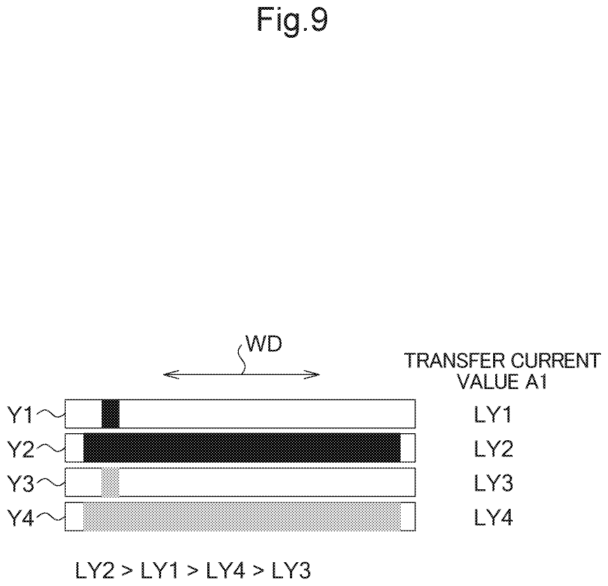

FIG. 9 is a diagram showing an example of a magnitude relationship of transfer current values required for transfer according to states of toner images. States Y1 to Y4 shown in FIG. 9 exemplify states of toner images formed on the furthest upstream photosensitive drum 121Y. Toner images indicated by the states Y1 and Y2 are solid images having the same density. Toner images indicated by the states Y3 and Y4 are halftone images having the same density. The image widths in the width direction WD of the toner images indicated by the states Y1 and Y3 are the same and are narrower than the image widths in the width direction WD of the toner images indicated by the states Y2 and Y4. The image widths in the width direction WD of the toner images indicated by the states Y2 and Y4 are the same.

In FIG. 9, the largest transfer current value required for transfer is a transfer current value LY2 for the state Y2, which has a high density and a wide image width. The next largest transfer current value is a transfer current value LY4 for the state Y4, followed by a transfer current value LY1 for the state Y1, and then a transfer current value LY3 for the state Y3. That is, the transfer current value LY3 for the state Y3, which has a low density and a narrow image width, is the smallest.

In the cases of single-color transfer and mixed-color transfer, even if the image area (image width) and the toner amount (density) of the toner image on the photosensitive drum 121 are the same, the latter requires a larger transfer current value. For example, when the toner image is a solid image (density 100%) and the image width is 10 mm, the required transfer current value is approximately 8.1 μA in the case of the single-color transfer as shown in FIG. 7A, whereas the required transfer current value is approximately 10.0 μA in the case of the mixed-color transfer as shown in FIG. 8A.

Moreover, when, at the transfer nip N1, an existing toner image formed on the intermediate transfer belt 125 by contact with the photosensitive drum 121 on the upstream side overlaps a toner image newly transferred onto the intermediate transfer belt 125 by the photosensitive drum 121 on the downstream side, the newly transferred toner image is placed on the existing toner image. However, because the resistance increases due to the existing toner image formed on the intermediate transfer belt 125, the transfer current value required for transferring the newly transferred toner image increases.

Therefore, in the present embodiment, when, at the transfer nip N1, an existing toner image formed on the intermediate transfer belt 125 by contact with the photosensitive drum 121 on the upstream side, or a toner layer formed by overlapping a plurality of existing toner images, overlaps a toner image newly transferred onto the intermediate transfer belt 125 by the photosensitive drum 121 on the downstream side, the controller 100 increases the transfer current value during transfer of the newly transferred toner image by a predetermined value in accordance with an amount of resistance increased by the existing toner image, as compared with when the existing toner image or toner layer does not overlap the newly transferred toner image.

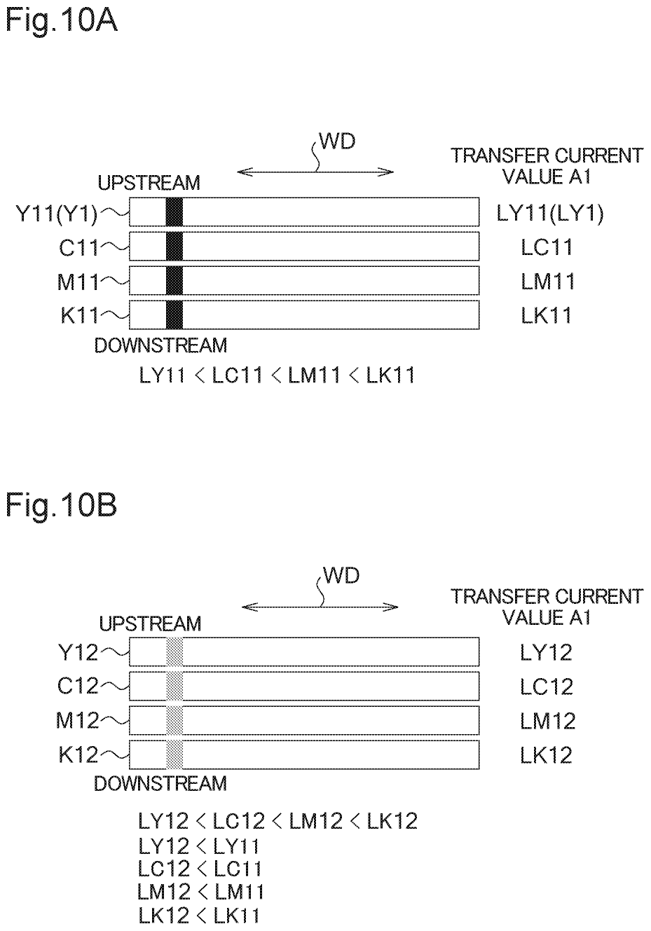

FIGS. 10A and 10B are diagrams showing examples of the magnitude relationship of transfer current values required for transfer according to states of toner images. In FIG. 10A, an example in which states Y11 (Y1), C11, M11, and K11 are states of toner images formed on the photosensitive drums 121Y, 121C, 121M, and 121K for respective colors, and these toner images are transferred to overlap at the same position in the width direction WD of the intermediate transfer belt 125 is shown. In this example, the toner images indicated by the states Y11, C11, M11, and K11 differ in color, but are all solid images having the same density and the same image width.

In FIG. 10B, another example in which states Y12, C12, M12, and K12 similarly are states of toner images formed on the photosensitive drums 121Y, 121C, 121M, and 121K for respective colors like the states Y11, C11, M11, and K11, and these toner images are also transferred to overlap at the same position in the width direction WD of the intermediate transfer belt 125 is shown. In this example, the toner images indicated by the states Y12, C12, M12, and K12 also differ in color, but are all halftone images having the same density and the same image width.

In the present embodiment, in the states Y11, C11, M11, and K11 shown in FIG. 10A, the smallest required transfer current value is the transfer current value LY11 for the state Y11, in which the toner image is formed on the furthest upstream photosensitive drum 121Y. The next smallest transfer current value is the transfer current value LC11 for the state C11, followed by the transfer current value LM11 for the state M11. The largest transfer current value is the transfer current value LK11 for the state K11, in which the toner image is formed on the furthest downstream photosensitive drum 121K. That is, in this case, the required transfer current values are set to satisfy LY11<LC11<LM11<LK11.

Likewise, in the present embodiment, in the states Y12, C12, M12, and K12 shown in FIG. 10B, the smallest required transfer current value is the transfer current value LY12 for the state Y12, in which the toner image is formed on the furthest upstream photosensitive drum 121Y. The next smallest transfer current value is the transfer current value LC12 for the state C12, followed by the transfer current value LM12 for the state M12. Also, the largest transfer current value is the transfer current value LK12 for the state K12 in which the toner image is formed on the furthest downstream photosensitive drum 121K. That is, in this case, the required transfer current values are set to satisfy LY12<LC12<LM12<LK12. Moreover, in the solid images shown in FIG. 10A and the halftone images shown in FIG. 10B, because the latter have a lower density, the latter require a smaller transfer current value if other conditions are the same.

Furthermore, a modification example of the present embodiment will be described. In the above description, transfer bias control for a case where toner images indicated by the states Y11, C11, M11, and K11 all have the same density and the same image width has been described. However, if the toner images indicated by the states Y11, C11, M11, and K11 overlap each other, the controller 100 may set the transfer current value to be used to transfer toner images from the downstream photosensitive drums 121 to the intermediate transfer belt 125 to a transfer current value (second value) decreased by a predetermined amount corresponding to a reduction in toner amount than a transfer current value used when the upstream toner image and the downstream toner image have the same density and the same image width when the toner amount of a toner image transferred to the intermediate transfer belt 125 by the photosensitive drum 121 arranged on the downstream side in the travel direction of the intermediate transfer belt 125 is smaller than the toner amount of a toner image transferred to the intermediate transfer belt 125 from the photosensitive drum 121 arranged on the upstream side in the travel direction, i.e., when the density of the toner image transferred to the intermediate transfer belt 125 by the photosensitive drum 121 on the downstream side is lower than that of the toner image on the upstream side or when the image width of the toner image on the downstream side is smaller than that of the toner image on the upstream side.

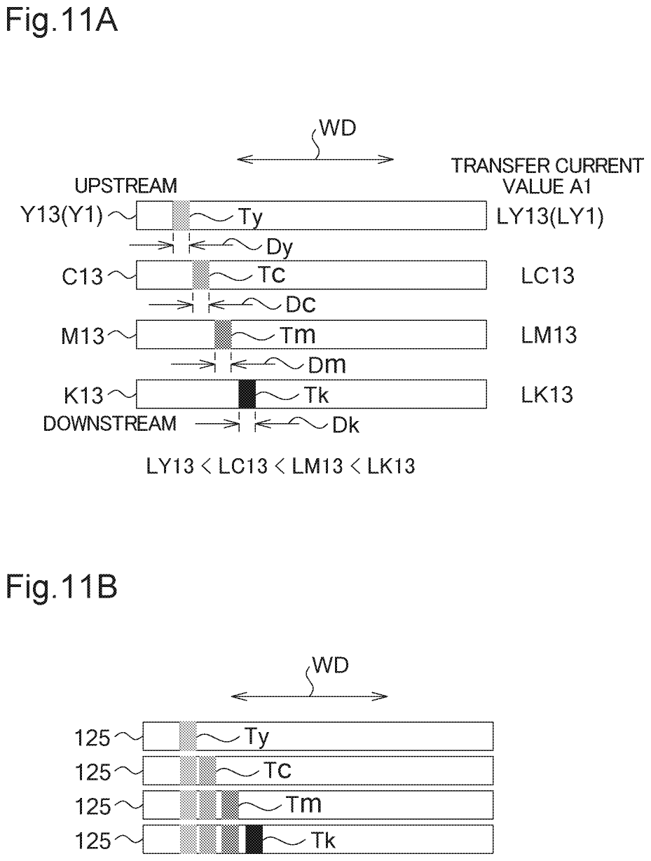

FIGS. 11A and 11B are diagrams showing an example of the magnitude relationship of transfer current values required for transfer according to states of toner images. FIG. 11A shows states of toner images formed on the photosensitive drums 121, and FIG. 11B shows the positional relationship when these toner images are transferred onto the intermediate transfer belt 125.

In the present embodiment, a case where states Y13 (Y1), C13, M13, and K13 shown in FIG. 11A are states of toner images Ty, Tc, Tm, and Tk formed on the photosensitive drums 121Y, 121C, 121M, and 121K for respective colors and these toner images are not transferred without overlapping at the same position on the intermediate transfer belt 125 in the width direction WD, but are transferred at the same position in the travel direction of the intermediate transfer belt 125 will be described. The toner images indicated by states Y13, C13, M13, and K13 differ in color, but are all solid images having the same density. The image widths of the toner images are denoted by Dy, Dc, Dm, and Dk. As described above, even if toner images are transferred to the same position in the travel direction of the intermediate transfer belt 125 and different positions in the width direction WD, each toner on the intermediate transfer belt 125 acts as resistance when the transfer bias is applied and affects the transfer.

Therefore, in the present embodiment, in the states Y13, C13, M13, and K13 shown in FIG. 11A, the smallest required transfer current value is the transfer current value LY13 for the state Y13, in which the toner image is formed on the furthest upstream photosensitive drum 121Y. The next smallest transfer current value is the transfer current value LC13 for the state C13, followed by the transfer current value LM13 for the state M13. Also, the largest transfer current value is the transfer current value LK13 for the state K13, in which the toner image is formed on the furthest downstream photosensitive drum 121K. That is, in this case, for transfer of the toner images indicated by the states Y13, C13, M13, and K13, the respective transfer current values selected from predetermined values are set to satisfy LY13<LC13<LM13<LK13.

That is, in the present embodiment, when, at the transfer nip N1, the toner image formed on the intermediate transfer belt 125 from the photosensitive drum 121 arranged on the upstream side in the travel direction of the intermediate transfer belt 125 is formed in an area identical with an area where a toner image is formed on the intermediate transfer belt 125 by the photosensitive drum 121 on the downstream side in the travel direction of the intermediate transfer belt 125, the controller 100 adds the area of the toner image formed on the intermediate transfer belt 125 from the photosensitive drum 121 arranged on the upstream side to the image area of the toner image formed on the intermediate transfer belt 125 by the photosensitive drum 121 on the downstream side and sets the transfer current value for transferring the toner image from the photosensitive drum 121 on the downstream side to the intermediate transfer belt 125 according to an addition result.

For example, the controller 100 performs control for applying a transfer bias using a transfer current value corresponding to the image width of the toner image by setting the image width to Dy for the state Y13, performs control for applying a transfer bias by setting the image width as Dy+Dc to the state C13, performs control for applying a transfer bias by setting the image width to Dy+Dc+Dm for the state M13, and performs control for applying a transfer bias by setting the image width to Dy+Dc+Dm+Dk for the state K13.

In the present embodiment, the transfer current value required for transferring the toner image is accurately set by performing the above-described transfer bias application control as described above, such that the occurrence of image defects is suppressed, the deterioration of the photosensitive drum 121 is prevented, and the durability of the photosensitive drum 121 is improved.

Some image forming apparatuses 1 include a charge removing device for removing charge from the photosensitive drum 121 and have a function of performing pre-transfer charge removal or post-transfer charge removal. In general, the charge removing device is provided on the upstream side with respect to the transfer nip N1 so that the pre-transfer charge removal is performed.

However, for reasons such as simplification of the apparatus, a configuration in which no charge removing device is provided for the furthest upstream photosensitive drum 121Y in the travel direction of the intermediate transfer belt 125, and charge removing devices are instead provided for the photosensitive drums 121C, 121M, and 121K located downstream thereof may be adopted. In this case, the pre-transfer charge removal is performed for the photosensitive drums 121C, 121M, and 121K other than the furthest upstream photosensitive drum, and is not performed for the furthest upstream photosensitive drum 121Y.

Therefore, as another embodiment, when the image forming apparatus 1 has such a configuration, the controller 100 performs the above-described transfer bias control based on information about the toner image on the photosensitive drum 121 for each of the photosensitive drums 121C, 121M, and 121K other than the furthest upstream one, but does not perform transfer bias control based on information about the toner image on the furthest upstream photosensitive drum 121Y. This is because, for the photosensitive drum 121Y for which the pre-transfer charge removal is not performed, a potential difference |Vo−Vt| between a surface potential Vo of the non-image area and a surface potential Vt of the solid image area becomes excessively large, making it difficult to suitably perform the above-described control.

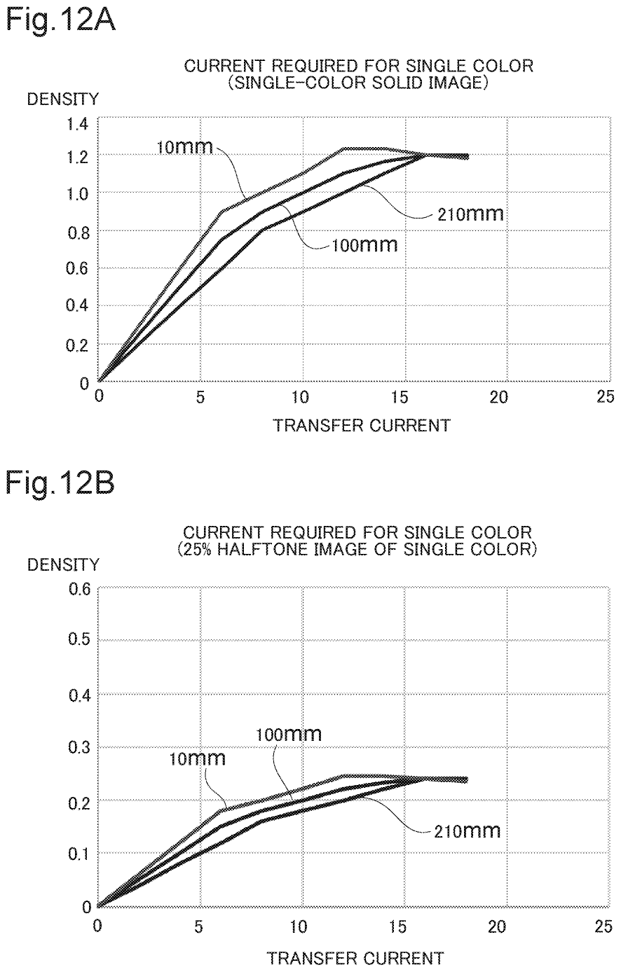

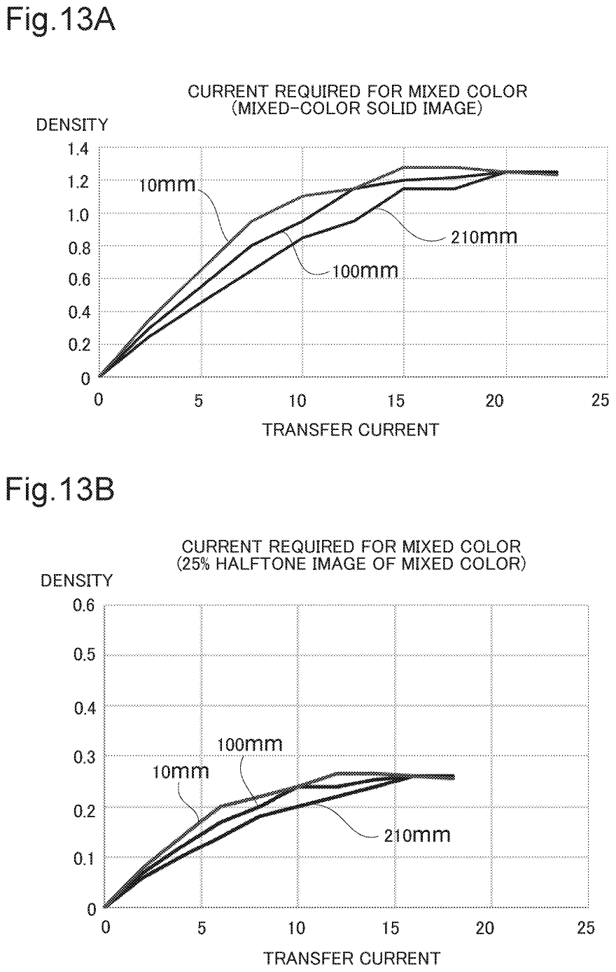

Next, conditions suitable for performing the above-described transfer bias control based on information about the toner image on the photosensitive drum 121 will be described. FIGS. 12A, 12B, 13A, and 13B are graphs showing the relationship between the density of a toner image formed on the photosensitive drum 121 and the transfer current required to transfer the toner image of that density to the intermediate transfer belt 125. Measured values shown in FIGS. 12A, 12B, 13A, and 13B are obtained using the photosensitive drum 121 in which the potential difference |Vo−Vt| between the surface potential Vo of the non-image area and the surface potential Vt of the solid image area is 300 V.

As shown in FIGS. 12A, 12B, 13A, and 13B, if the above-described potential difference is as large as 300 V, it is not possible to confirm a difference between transfer current values due to the image width of the toner image. That is, transfer bias control based on the image area of the toner image is not effective. Accordingly, when the transfer bias control is performed according to the present embodiment, it is preferable to perform the control when the potential difference is within a range of approximately 100 V, as shown in FIGS. 7A, 7B, 8A, and 8B.

Incidentally, the transfer current value required to transfer a toner image from the photosensitive drum to the intermediate transfer belt is generally set to be larger than the transfer current value required to transfer the maximum toner amount of a toner image to be transferred, to increase the toner transfer efficiency (Amount of toner transferred to the intermediate transfer belt/Amount of toner on the photosensitive drum).

Therefore, depending on the toner amount of the toner image to be transferred, the transfer current may become excessive, possibly causing image defects such as image unevenness or transfer memory (a defect appearing during a subsequent image forming operation). For example, because the resistance values differ between an area where a toner image is formed (image area) and an area where no toner image is formed (non-image area) on the photosensitive drum, the transfer current may flow from the image area into the non-image area having a lower resistance value and there is a possibility that the transfer memory may be generated. Moreover, when a large amount of current flows into the non-image area, wear of the surface layer of the photosensitive drum may progress, possibly shortening the lifespan of the photosensitive drum.

For example, as a general technique relating to toner image transfer, there is provided a technique in which pre-transfer charge removal is performed to remove unnecessary charges on the photosensitive drum before transferring the toner image to the intermediate transfer belt, thereby making the potential of the image area on the photosensitive drum higher than that of the non-image area. However, toner may scatter significantly when the toner image is transferred from the photosensitive drum to the intermediate transfer belt in such a potential relationship.

Moreover, as another general technique, there is provided a technique in which the level of generation of the transfer memory is predicted and the transfer current is controlled in accordance with the prediction, but control based on such prediction lacks accuracy.

Moreover, as still another general technique, there is provided a technique in which the transfer current is controlled based on the image area ratio formed on the photosensitive drum, and the transfer current is reduced for photosensitive drums located further downstream. However, this requires increasing the transfer current for the furthest upstream photosensitive drum, raising concerns about excessive current.

Moreover, as yet another general technique, there is provided a technique in which the transfer current increases as an image area formed in the longitudinal direction of the photosensitive drum decreases. However, even with control by this technique, there remains a risk that a large transfer current will flow into the non-image area.

The above-described embodiment has been made in view of the above-described circumstances, and improves the durability of the photosensitive drum by accurately setting the transfer current value required for transferring the toner image and suppressing the occurrence of image defects.

The present disclosure is not limited to the configurations of the above-described embodiments, and various modifications are possible. Moreover, the configurations and processes described in the above-described embodiments with reference to FIGS. 1 to 13B are merely examples of the present disclosure, and the present disclosure is not intended to be limited to those configurations and processes.

While the present disclosure has been described in detail with reference to the embodiments thereof, it would be apparent to those skilled in the art that the various changes and modifications may be made therein within the scope defined by the appended claims.

What is claimed is:

1. An image forming apparatus comprising:
a plurality of image carriers provided for a plurality of colors and configured to rotate about a rotation axis and carry a toner image;
a plurality of charging devices provided for the plurality of colors and configured to charge surfaces of the image carriers;
a plurality of exposure devices provided for the plurality of colors and configured to expose the surfaces of the image carriers to form electrostatic latent images on the surfaces of the image carriers;
a plurality of developing devices provided for the plurality of colors and configured to supply toner to the surfaces of the image carriers to develop the electrostatic latent images formed on the surfaces of the image carriers and form toner images;
an intermediate transfer medium configured to travel in a direction in which the image carriers are arranged and sequentially contact the surfaces of the image carriers, the toner images on the image carriers being transferred onto the intermediate transfer medium;
a plurality of transfer devices provided for the plurality of colors and configured to transfer the toner images on the corresponding image carriers to the intermediate transfer medium; and
a control device including a processor,
wherein, when the processor executes a control program, the control unit functions as a controller which controls a transfer bias to be applied to the transfer devices by setting a value of a transfer current flowing through a transfer device to a smaller value when an image area of the toner image in a longitudinal direction corresponding to a rotation axis direction of the image carrier becomes narrower on the basis of information about the toner image on the image carrier at a transfer nip formed between the image carrier and the intermediate transfer medium and setting the transfer current value to a smaller value when a toner amount of the toner image becomes smaller.

2. The image forming apparatus according to claim 1, wherein, when a toner image formed on the intermediate transfer medium from an image carrier arranged on an upstream side in a travel direction of the intermediate transfer medium overlaps a toner image transferred to the intermediate transfer medium by an image carrier arranged on a downstream side in the travel direction at the transfer nip, the controller increases the transfer current value of the transfer device that transfers the toner image from the image carrier on the downstream side to the intermediate transfer medium by a predetermined value as compared with when the toner images do not overlap.

3. The image forming apparatus according to claim 1, wherein, when a toner image formed on the intermediate transfer medium from an image carrier arranged on an upstream side in a travel direction of the intermediate transfer medium overlaps a toner image transferred to the intermediate transfer medium by an image carrier arranged on a downstream side in the travel direction at the transfer nip,
if a toner amount of the toner image to be transferred to the intermediate transfer medium by the image carrier on the downstream side in the travel direction is equal to or greater than a toner amount of the toner image formed on the intermediate transfer medium from the upstream image carrier in the travel direction of the intermediate transfer medium,
the controller increases the transfer current value of the transfer device that transfers the toner image from the image carrier on the downstream side to the intermediate transfer medium by a predetermined first value as compared with when the toner images do not overlap.

4. The image forming apparatus according to claim 3, wherein, when the toner image formed on the intermediate transfer medium from the image carrier arranged on the upstream side in a travel direction of the intermediate transfer medium overlaps the toner image transferred to the intermediate transfer medium by the image carrier arranged on the downstream side in the travel direction at the transfer nip,
if the toner amount of the toner image to be transferred to the intermediate transfer medium by the image carrier on the downstream side in the travel direction is less than the toner amount of the toner image formed on the intermediate transfer medium from the upstream image carrier in the travel direction of the intermediate transfer medium,
the controller sets the transfer current value of the transfer device that transfers the toner image from the image carrier on the downstream side to the intermediate transfer medium to a second value that is smaller than the first value by a predetermined value.

5. The image forming apparatus according to claim 1, wherein, when a toner image formed on the intermediate transfer medium from an image carrier arranged on an upstream side in a travel direction of the intermediate transfer medium is formed in an area identical with an area where a toner image is formed on the intermediate transfer medium by an image carrier arranged on a downstream side in the travel direction of the intermediate transfer medium at the transfer nip,
the controller adds an area of the toner image formed on the intermediate transfer medium from the image carrier arranged on the upstream side to an image area of the toner image formed on the intermediate transfer medium by the image carrier on the downstream side and sets the transfer current value of the transfer device for transferring the toner image from the image carrier on the downstream side to the intermediate transfer medium according to an addition result.

6. The image forming apparatus according to claim 1, further comprising a charge removing device provided on a downstream side of each transfer nip for each image carrier other than a furthest upstream image carrier and configured to remove charge from the image carrier,
wherein the controller
causes each charge removing device to perform pre-transfer charge removal from each image carrier other than the furthest upstream image carrier, and
performs control of a transfer bias based on information about the toner image on the image carrier for each image carrier other than the furthest upstream image carrier.

7. The image forming apparatus according to claim 1, wherein, in the image carrier, an absolute value |Vo| of a surface potential Vo of a non-image area is equal to or greater than an absolute value |Vt| of a surface potential Vt of a solid image area having a density of 100%, and a potential difference |Vo −Vt| at the transfer nip is within 100 V.

8. The image forming apparatus according to claim 1, wherein the controller
controls the transfer bias to be applied to each transfer device other than a transfer device arranged at a furthest upstream position in a travel direction of the intermediate transfer medium on the basis of information about the toner image on the image carrier with respect to the transfer device, and
does not execute a control process that controls the transfer bias to be applied to the transfer device arranged at the furthest upstream position in the travel direction of the intermediate transfer medium on the basis of the information about the toner image on the image carrier with respect to the transfer device.
